(19) United States
(12) Patent Application Publication
(10) Pub. No.: US 2006/0226231 A1
(43) Pub. Date: Oct. 12, 2006

(54) Methods and systems for creating sequential color images

(75) Inventors: Richard S. Johnston, Sammamish, WA (US); Cameron M. Lee, Edmonds, WA (US); Charles D. Melville, Issaquah, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: University of Washington, Seattle, WA (US)

(21) Appl. No.: 11/094,017

(22) Filed: Mar. 29, 2005

(51) Int. Cl. G06K 7/10

(52) U.S. Cl. 235/462.45

(57) ABSTRACT

The present invention provides methods, software, and systems that allow a scanning beam device to create full or partial color images using sequential color methods. The methods of the present invention may use sequential color concepts to improve image generation without increasing scan rates while using light source modulation rates that are much less than conventional methods.

### BACKGROUND OF THE INVENTION

The present invention relates generally to generating color images of a target area. More specifically, the present invention provides methods and scanning beam devices that create full or partial color images using frame sequential methods, pixel sequential methods, or a combination thereof.

A scanning beam device developed by the University of Washington Human Interface Technology Laboratory (HITL) uses a scanning element in the form of a single cantilevered optical fiber. A drive assembly scans the cantilevered optical fiber in a predetermined scan pattern over a target area to deliver illumination to the target area. Light reflected from the target area is sequentially captured by one or more detectors coupled to the scanning beam device and the detector response is used to determine the brightness of the small portion of the target area that corresponds to the small area illuminated by the optical fiber at that given point in time.

While monochromatic images of the target area may be sufficient, in many cases it is desirable to create color images of the target area. Color images may be accomplished by illuminating the target area with continuous or modulated light from different wavelength/colored laser sources. For full colored images, typically three different wavelength sources are used (e.g., red, blue, and green). The reflected light from each source may thereafter be individually collected by the light detectors.

There are two conventional methods to create color images of the target area—a continuous color method and a sequential color method. In the continuous color method, all of the color sources are continuously scanned over the target area at the same time. Multiple light detectors are concurrently used to detect the reflected light from the target area. Unfortunately, because one light detector is needed for each color source, the size of the scanning beam device is increased to accommodate all of the light detectors. Additionally, a significant loss of data may occur during separation of the colors from each other.

A sequential color image is generally created by turning on one light source at a time and recording the power of the reflected light from the target area. Conventional sequential color methods include both frame sequential color methods and pixel sequential color methods. In frame sequential color methods, a single color light source is scanned in the scan pattern over the target area and the reflected light is reflected from the target area to generate a monochromatic image of the target area. Once the first scan pattern is completed with the first color light source, the scan pattern is repeated with a second color light source, then a third color light source, and the like, and different monochromatic images of the target area are generated. After all of the desired color light sources are scanned over the target area, the different colored monochromatic color images are combined to create a multiple-colored image (typically a full color image) of the target area. To update the multiple-colored image, each of the single color light sources are scanned over the target area again and monochromatic images of the target area are then generated, and after all of the single color light sources have been scanned over the target area, the new single color images are combined to generate a second multiple-colored image of the target area. The second multiple colored image is then used to replace/refresh the first multiple colored image that is displayed. However, a major disadvantage of such methods is that the frame rate and detector bandwidth must be multiplied by the number of colors used and the scan frequency must also be increased. For three color images (e.g., red, green and blue), such methods require scan rates that are three times that of a monochromatic image.

In the pixel sequential process, during the scan pattern the different light sources are modulated at the pixel rate with each light source being on for a portion of the pixel time. For example, for three light sources, each light source is on for ⅓ of the pixel time. The major disadvantages of the pixel sequential method are that the sources must be modulated at the pixel rate (a very expensive process), each of the red, blue and green frames are slightly offset from each other, and the detector bandwidth must be multiplied by the number of sources (e.g., three).

While the existing methods of creating color images have proven to be useful, improvements in creating color images of a target are still needed. It would be preferable if such methods and systems could generate the color images with a single detector. It would be further preferable that the detector use a sequential color method that does not require a frame rate to be increased or the rapid modulation of the color sources. At least some of these needs are met by the methods and systems of the present invention.

### BRIEF SUMMARY OF THE INVENTION

The present invention provides methods, software, and systems that allow a scanning beam device to create full or partial color images using sequential color methods. The methods of the present invention may use sequential color concepts to improve image generation without increasing scan rates while using light source modulation rates that are much less than conventional methods.

In one embodiment, the present invention generates an image in which a first portion of the image is in multiple colors and a second portion of the image is monochromatic (e.g., a single color or gray scale). In a preferred embodiment, the first portion of the image is at a center portion of the image and the second portion of the image is an annular portion around the center portion. In many instances, the most important part of the target area that is imaged will be in a center portion of the scan, and the monochromatic portion of the image will not affect the overall image of the target area.

One method that may be used to generate the partially colored image uses pixel sequential methods only near a center portion of the scan where pixel rates are low. On the outer portion of the image, where pixel rates are high, the method uses frame sequential concepts to generate the monochromatic portion.

In one specific embodiment, the method comprises positioning a scanning beam device adjacent the target area. The illumination is scanned over the target area in a scan pattern. Multiple illumination sources are continuously modulated over the first portion of the scan pattern and a single illumination source is scanned over the second portion of the scan pattern. Thereafter, an image is generated in which a first portion of the image (which corresponds to the first portion of the scan pattern) is displayed in multiple colors and a second portion of the image (which corresponds to the second portion of the scan pattern) is displayed in a single color or gray scale.

In another embodiment, the present invention generates a full color image that is comprised of a plurality of different colors (typically three colors). Such an image is generated using frame sequential methods. In frame sequential methods, different illumination sources are sequentially scanned in the scan pattern over the target area. Light reflected from the target area is collected during the scanning of each of the illumination sources. The reflected light from the target area is used to generate single color images of the target area. The single color images of the different illumination sources are combined to provide a multiple colored frame image of the target area. The multiple-colored frame image of the target area may be updated by sequentially replacing each single color image with a subsequently generated single color image of the same color.

Advantageously, unlike conventional frame sequential methods which update the multiple-colored image with a completely new set of single color images, the multiple colored image of the present invention is refreshed after each of the subsequently single color images are captured. Thus, the refresh rate of the multiple colored image will be much faster than conventional methods (for three images, the refresh rate will be three times faster) and any motion at the target area will be smoothed so as to provide an improved image. Moreover, in conventional frame sequential methods, each of the single color images will be used in only one multiple color image. In contrast, each of the single color images the methods of the present invention will be used in three multiple color images.

Optionally, image processing may be used to extract one or more features from each of the single color images as it is captured. A position and orientation of the feature(s) in the images may be analyzed to determine if translation and/or rotation of the previously captured images are needed before they are combined with the subsequently captured image.

In other embodiments of the present invention, it may be possible to combine the pixel sequential method of the present invention with the frame sequential methods of the present invention. Advantageously, this provides for a reduced modulation rate of the light sources, fast refresh rate in a center portion of the image, while providing a full color image over the entire image.

Other aspects, objects and advantages of the invention will be apparent from the detailed description that follows.

### BRIEF DESCRIPTION OF THE DRAWINGS

FIG. 1 illustrates a Q-factor of a resonant frequency.

FIG. 2 illustrates an exemplary two-dimensional spiral scan pattern that is encompassed by the present invention.

FIG. 3 illustrates one exemplary y-axis drive signal and z-axis drive signal that may be used to generate the scan pattern of FIG. 2.

FIG. 4 illustrates an image in which a first, central portion comprises multiple colors and a second, annular portion comprises a single color.

FIG. 5 illustrates one conventional frame sequential method of generating and updating a multi-colored frame image.

FIG. 6 illustrates an improved frame sequential method of generating and updating a multi-colored frame image in which the composite, multi-colored frame image is updated after each single color image is captured.

FIGS. 7 and 8 illustrate a method which incorporates both a pixel sequential method and a frame sequential method to generate and update a multi-colored frame image.

FIG. 9 illustrates a scanning beam system encompassed by the present invention.

FIG. 10 illustrates a simplified scanning fiber system encompassed by the present invention.

FIG. 11 illustrates a simplified kit encompassed by the present invention.

### DETAILED DESCRIPTION OF THE INVENTION

Scanning beam systems of the present invention may be used for image acquisition of a target area or for displaying an image on a target area. The scanning beam systems of the present invention typically include a scanning beam device, and a base station for controlling the scanning beam device. The scanning beam devices of the present invention may take on a variety of forms, but are typically in the form of a flexible or rigid endoscope, catheter, fiberscope, microscope, a boroscope, or a display. The scanning beam devices of the present invention may be a limited use device (e.g., disposable device) or a multiple-use device. If the device is for medical use, the scanning beam devices of the present invention will generally be sterile, either being sterilizable or being provided in hermetically sealed package for use.

The scanning beam devices of the present invention include a scanning element for scanning a beam of light onto a target area. The scanning element preferably comprises a single, cantilevered optical fiber, but in other embodiments, the scanning element may take the form of mirrors, such as microelectomechanical system (MEMS), galvanometer, a polygon, multiple optical elements moved relative to each other, or the like.

The scanning elements of the present invention are driven with a drive assembly that is in communication with the base station. In preferred embodiments, the drive assembly is a piezoelectric driving assembly. A drive signal from a controller of the base station delivers a drive signal to the drive assembly. The drive signal causes the piezoelectric drive assembly to deflect the optical fiber so that the illumination spot is scanned in a desired scan pattern over the target area. While preferred drive assemblies are piezoelectric assemblies, in alternative embodiments, the drive assembly may comprise a permanent magnet, a electromagnet, an electrostatic drive, a sonic drive, an electro-mechanical drive, or the like.

While the remaining discussion of the methods, software, and systems of the present invention focus on the use of a two-dimensional spiral scan pattern, it should be appreciated however, that the present invention is not limited to such a scan pattern and other scan patterns may be equally applicable. For example, the present invention may also use other two dimensional scan patterns such as a rotating propeller scan pattern, a raster scan pattern, or even a one-dimensional line pattern.

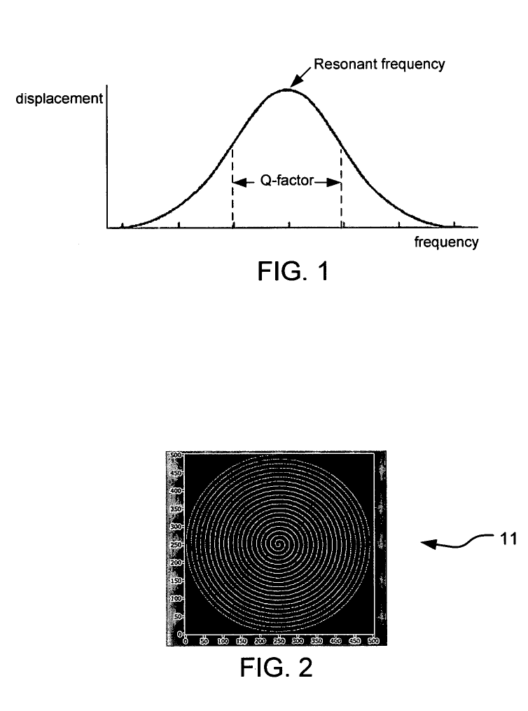

Referring now to FIG. 1, it has been found that it is preferable that the drive signal be at a frequency that is within a Q-factor of the resonant frequency of the scanning element, and preferably at its mechanical or vibratory resonant frequency (or harmonics of the resonant frequency). As can be appreciated however, the scanning element does not have to be driven at substantially the resonant frequency. But, if the scanning element is not scanned at its resonant frequency, a larger amount of energy will be required to provide the desired radial displacement for the scan pattern.

FIG. 2 illustrates an idealized spiral scan pattern 11 in which the scanning element and illumination spot start at an initial, substantially central position and spirals outward until a maximum desired diameter is reached. Once the scanning element and illumination spot reaches its maximum diameter, it is desirable to return the illumination spot to the center so that the scan pattern can be repeated. Of course, in other embodiments it may be possible to start the scan pattern at its maximum diameter and then spiral the illumination spot inward toward the middle.

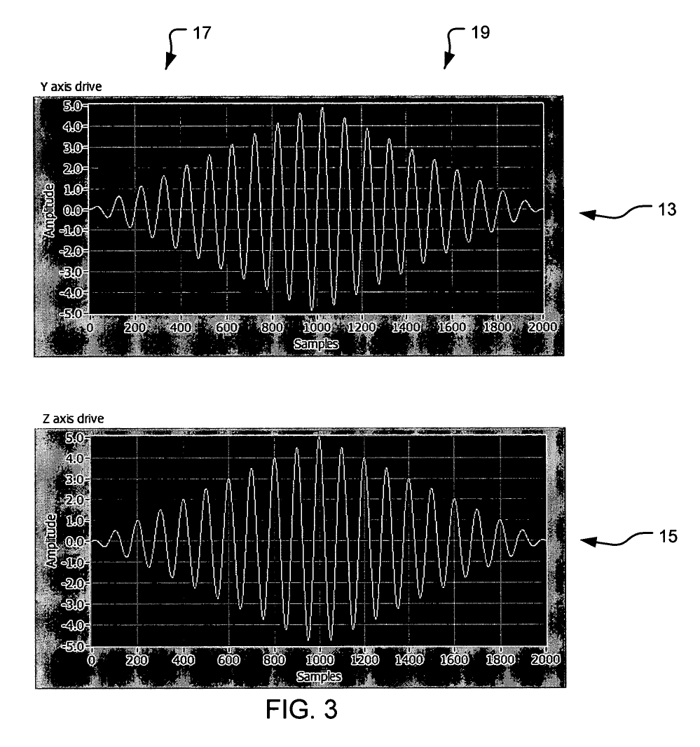

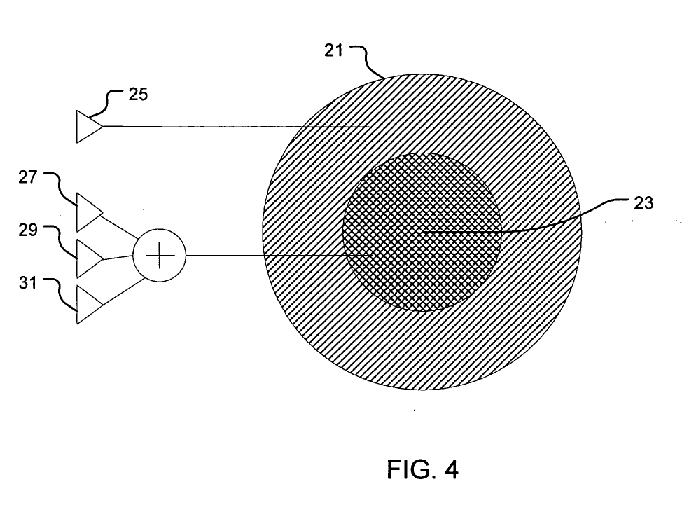

A variety of different drive signals may be used to achieve the resonant spiral scan pattern 11 of FIG. 2. For example, the scanning element may be driven along two drive axes (y and z or horizontal and vertical) with a triangle amplitude modulated sine waves 13, 15 that are driven with a 90 degree phase shift between them (FIG. 3). If the scanning element is a circular optical fiber, the horizontal and vertical resonant vibrations will have the same frequency and equal amplitude (but still 90 degrees out of phase). A first, increasing amplitude portion 17 of the drive signals 13, 15 cause the illumination spot to spiral outward from the initial, central position.

The second (e.g., decreasing amplitude) portion 19 of the drive signals 13, 15 theoretically causes the illumination spot to spiral inward, back to the initial, substantially central position. In practice however, Applicants have found that the second, decreasing amplitude portion 19 does not always return the illumination spot to the center, and the amplitude of the second portions of the drive signals may need to be modified to return the illumination spot substantially back to the center. A more complete description of exemplary drive signals and scan envelopes that may be used to spiral the illumination spot outward and return it substantially to the center is described in commonly owned, copending U.S. patent application Ser. No. 11/021,981, filed Dec. 23, 2004, entitled “Methods of Driving a Scanning Beam Device to Achieve a High Frame Rate,” the complete disclosure of which is incorporated herein by reference.

Referring again to FIG. 2, because the spiral frequency and period of a each spiral in the spiral scan is constant, when the scanning element and illumination spot are spiraling outward from center position, the linear velocity for the scanning element (and hence the illumination spot) is minimum in the center of the scan pattern (where the spirals are small), and is maximum at the outermost spiral (where the spiral is the largest). Additionally, because the pixels in a computer monitor or other standard display devices are uniformly spaced, in a spiral scan pattern, the inner spirals map to fewer pixels than the outer spirals. Stated another way, during the scan pattern the illumination spot will reside over a single pixel a longer amount of time for the inner spirals than for the outer spirals.

The present invention provides a plurality of methods, systems and software for creating color images that take advantage of the differing linear velocities of the illumination spot and the time that the illumination spot resides on each pixel to provide color images at an improved frame rate. The various methods of the present invention described herein may be used independently or in combination with each other. While the methods of the present invention are described in relation to an image capture device, the methods of the present invention will work equally well with a laser scanning display.

FIG. 4 illustrates one method encompassed by the present invention in which a different number of light sources are used for different portions of the scan pattern. As shown in FIG. 4, the spiral scan pattern (and frame image) may be arbitrary divided into an outer portion 21 and an inner portion 23. Of course, in other embodiments, depending on the rate of modulation and other factors, the spiral scan pattern 11 may be divided up into any number of portions.

For the outer portion 21, where the pixel rates are high, a single light source 25 is used. As noted above, because of the longer linear length of each spiral and the faster linear velocity of the illumination spot, the light source 23 is able to spend a shorter amount of time over each pixel in the outer portion 21. Because only a single light source is used, no modulation is needed within the outer portion of the scan pattern, and the illumination spot is able to spend a longer amount of time over each pixel in the outer portion.

For the inner portion 23, where the pixel rates are lower, multiple light sources 27, 29, 31 are rapidly modulated for each pixel of the inner portion. Since the linear length of each of the spirals in the inner portion 23 is shorter than a linear length of the spirals in the outer portion 21 of the scan pattern and the linear velocity is slower, the illumination spot is able to spend a longer amount of time over each pixel. The longer amount of time allows for modulation of the light sources, without detrimentally affecting the frame rate. Unlike a full pixel sequential process—which modulates multiple light sources over each pixel of the entire scan pattern, the method of the present invention does not modulate the light sources at the high pixel rates on the outer portion of the scan pattern, but only modulates the light sources at the reduced rates in the inner portion of the scan pattern.

After the scan pattern has been completed, a frame image is generated in which an outer portion of the frame image is monochromatic (e.g., single color or gray scale) and the inner portion of the frame image is multi-colored. In most embodiments, the center portion of the image (e.g., inner portion) is the area of greatest importance, and the monochromatic outer portion of the image does not detrimentally affect the imaging of the target area. As can be appreciated, while a single colored light source (red, green, blue) may be used for the outer portion 21 of the scan pattern, the base station of the present invention may be configured to display the outer portion of the target area in a gray scale instead of a single color.

Because the transition point between the outer portion 21 and the inner portion 23 is arbitrarily set, there may be a sharp contrast at the point where the modulation stops. To create a more smooth transition between the multi-colored image and the monochromatic image, it may be desired to include a transition portion between the outer portion 21 and inner portion. While not shown, the method of FIG. 4 may optionally include one or more transition portions between the outer portion 21 and the inner portion 23. The transition portion may use a less number of light sources than the inner portion 23 and a larger number of light sources than the outer portion 21. For example, if the inner portion 23 modulates three light sources (e.g., red, green, blue) and the outer portion 21 uses only a single light source, the transition portion may modulate between only two light sources. In such embodiments, the resultant frame image will have a full colored inner portion, a multi-colored transition portion, and a monochromatic outer portion.

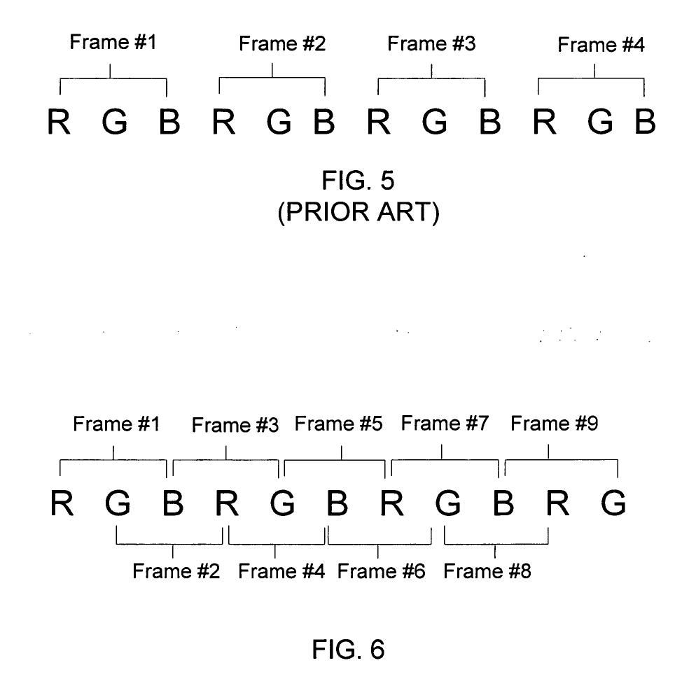

In another aspect, the present invention provides an improved frame sequential method that generates a full, multi-colored image. FIG. 5 illustrates a conventional frame sequential method in which a single light source (Red “R”) is scanned in the scan pattern over the target area. The scan pattern is thereafter repeated with each of the different light sources (Green “G” and then Blue “B”). In the illustrated method, the color sequence includes a combination of red, blue and green light sources (RGB). In such frame sequential methods, the multi-color image displayed is a combination of three sequentially collected frame images of different colors (RGB) of the target area. The multi-color image is shown in FIG. 5 as Frame #1. In such methods, the multi-color image is updated after all of the single color images are updated, as shown by Frame #2, Frame #3, etc.

FIG. 6 illustrates an improved frame sequential method encompassed by the present invention that updates the multi-colored frame image after each single color image is captured. In addition to being applicable to a spiral scan pattern, the frame sequential methods of the present invention are equally applicable with other scan patterns (e.g., raster, etc.). As shown in FIG. 6, after the initial red, blue and green images are captured, the single colored images are combined to generate Frame #1. The first red image is replaced by the subsequently captured red image, and the second red image is combined with the original green and blue images to generate Frame #2. In such methods, almost every captured single color image is used to create three different multi-colored image. For example, the first blue image (B) is used in Frame #1, Frame #2, and Frame #3. In contrast, as shown in FIG. 5, in conventional frame sequential methods, each single color frame image is only used once. Such a method provides a reduced frame rate and smoothes motion between the frame images.

Optionally, it may be desirable to use image processing to extract important features of each single color image as each image is captured. A position and/or orientation of the extracted feature(s) may be calculated after each of the single color images is captured. The position/orientation information of each feature may be used by the software of the present invention to compare its position and orientation to the position and orientation of the feature in the other, previously captured single color images to determine if rotation and/or translation of the previously captured single color image is needed before they are combined with the subsequently captured single color images. However, since the motion will be small between each single color image, it is likely that only small adjustments are needed and imaging errors should be minimal.

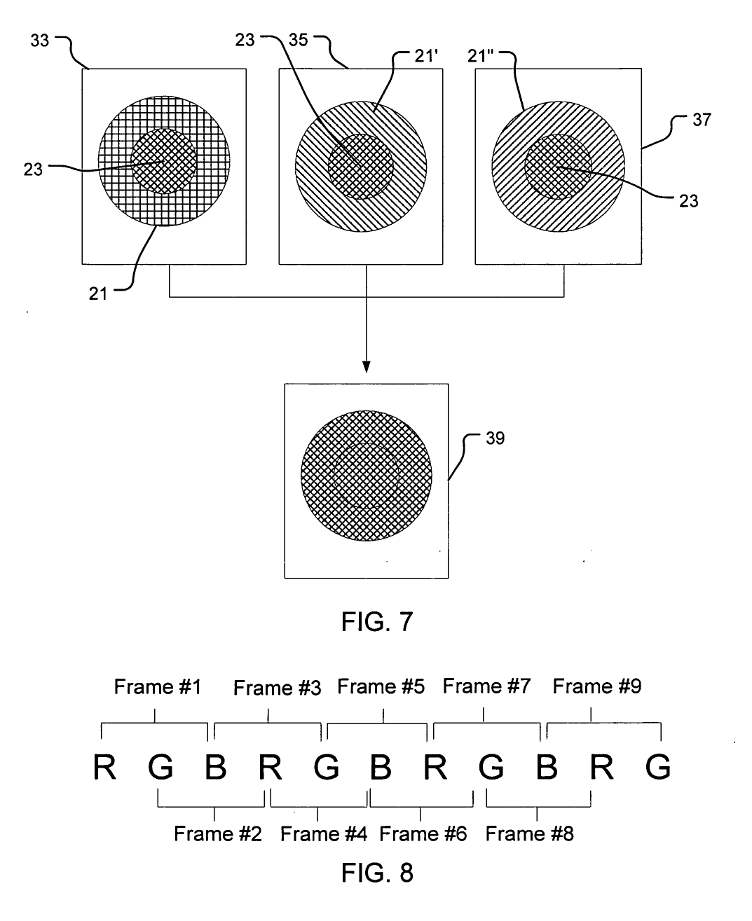

FIGS. 7 and 8 illustrate a method with incorporates both the pixel sequential method and a frame sequential method of the present invention. Advantageously, the method of FIGS. 7 and 8 provide the reduced modulation rates of the pixel sequential method (FIG. 4), while providing a full color image of the frame sequential method (FIG. 6). Such methods provide a full color frame image and fast updates of the center portion of the frame image.

In such methods, the scanning beam device is positioned adjacent the target area. The illumination source and drive assembly may then be activated to scan the illumination spot over the target area in a desired scan pattern. Similar to previous embodiments, in such methods the scan pattern may take on a variety of different uniform and non-uniform patterns. In a preferred embodiment the scan pattern is a spiral scan pattern that starts from its center and spirals outward.

During a first, inner portion 23 of the scan pattern, where the pixel rates are low, the illumination sources are modulated so that each pixel is imaged with multiple light sources over the predetermined inner portion 23 of the scan pattern. During the second, outer portion 21 of the scan pattern, where the pixel rates are higher, only a single illumination source is used. Light reflected from the target area is sequentially collected and the collected light from one cycle is used to generate a first frame image 33 (FIG. 7) of the target area in which the inner portion 23 of the frame image (which corresponds to the first portion of the scan pattern) is comprised of multiple colors, and the second, outer portion 21 of the frame image 33 (which corresponds to the second portion of the scan pattern) is comprised of a single color.

Thereafter, the illumination spot is returned to the center and the illumination spot is again scanned in substantially the same scan pattern over the target area. The only difference with the subsequent scan pattern from the first scan pattern is use of a different color of light for the second, outer portion of the scan pattern. Consequently, the subsequently captured frame images 35, 37 will have a different color in the outer portion 21′, 21″. As shown in FIG. 7, a second frame image 35 will have a multi-colored inner portion 23 and a different, single color outer portion 21′ and the third frame image 37 will also have a multi-colored inner portion 23 and a different, single color outer portion 21″.

As shown in the example of FIG. 8 the first outer portion 21 may be imaged with a red light source (R), the second outer portion 21′ may be imaged with a green light source (G), and the third outer portion 21″ may be imaged with a blue light source (B). As can be appreciated, the present invention is not limited to such a specific pattern of color of light sources (e.g., RGB), and other patterns may be used (e.g., RBG) or completely different colors may be used.

Once the scan pattern has been repeated the desired number of times (e.g., three) in which all of the frame images have different colored second portions, the frame images 33, 35, 37 are combined. When all three of the images 33, 35, 37 are combined, the resultant combined frame image 39 (shown as Frame #1 in FIG. 8) will be multi-colored in both the inner portion 23 and outer portion 21 (e.g., combination of red, green and blue). In such a combined image, the inner portion of the last captured image (e.g., frame image 37) is used for the center portion 23 and the outer portion 21 is a combination of the outer portions 21, 21′, 21″ of the three frame images 33, 35, 37.

To update the full-color image 39, subsequently captured frame images having a single colored outer portion 21 (not shown) is combined with the last two captured frame images that have different colored outer portions 21 to generate the updated composite frame image (e.g., shown as Frame #2 in FIG. 8). For example, as shown in FIGS. 7 and 8, the first frame image 33 that has the red colored second portion is replaced with a subsequently captured image with a red colored second portion. The updating process will continue through all of the colors, sequentially replacing the “old” frame images of one color with a “new” frame image of the same color. While the outer portion 21 only updates a single color with each subsequent frame image, the multi-colored inner portion 23 is updated with each frame image. Because each frame image already has a multi-colored inner portion 23, each composite frame image may just use the most recently captured inner portion for display.

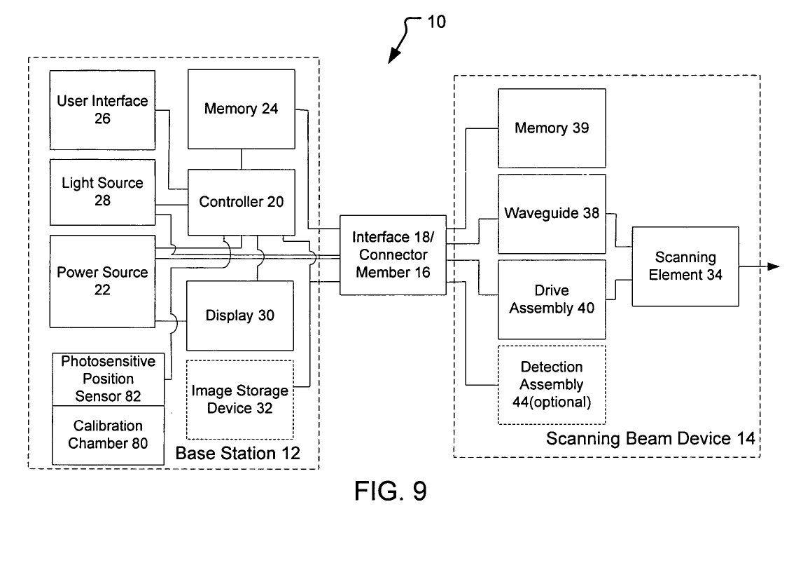

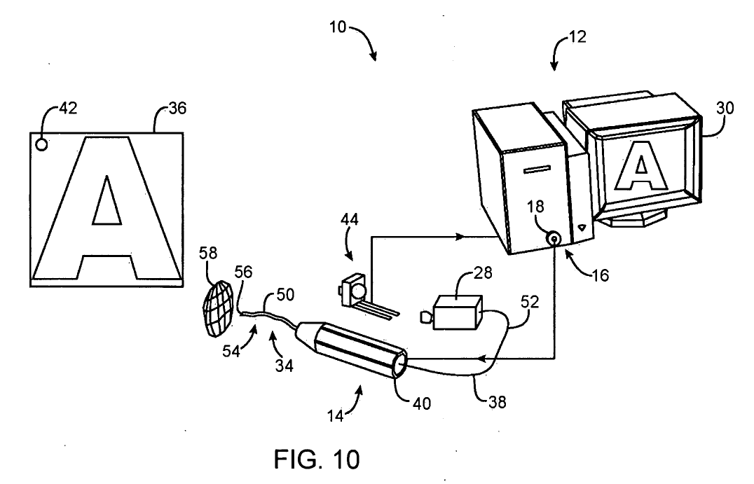

FIGS. 9 and 10 illustrate scanning beam systems 10 that may carry out the methods described above. The scanning beam system 10 may include a base station 12 and a scanning beam device 14. The scanning beam device 14 includes a connector member 16 that is configured to mate with an input interface 18 on the base station. Coupling of the connector member 16 to the input interface 18 may create a power path, drive signal path, detector path, illumination path, and/or data communication path between elements of the base station 12 and related elements of the scanning beam device 14.

As shown in FIG. 9, base station 12 typically includes a controller 20 that has one or more microprocessors and/or one or more dedicated electronics circuits which may include a gate array (not shown) which may control the actuation of the scanning beam device 14 and generation of the images. The controller 20 may also include scanner drive electronics, detector amplifiers and A/D converters (not shown). The drive electronics in the controller and the software modules stored in memory are used to provide a customized control routine for the scanning beam device 14. The methods of the present invention may be implemented with hardware, software, firmware, specialized circuitry, specialized processors, or a combination thereof. In embodiments, in which the methods are carried out as software, the software is preferably implemented as an application program in the form of a plurality of software modules that are tangibly embodied in a memory of the system or on other computer readable medium. While the remaining discussion focuses on a software implementation of the methods of the present invention, it should be appreciated that the present invention is not limited to the software implementation.

Controller 20 is in communication with a plurality of elements within the base station 12 via a communication bus. The communication bus typically allows for electrical communication between controller 20, a power source 22, memory 24, user interface(s) 26, light sources 28, one or more output displays 30, and a photosensitive position sensor 82. Optionally, if the scanning beam device 14 includes a detection assembly, the base station 12 may include a separate image storage device 32 in communication with controller 20. In alternative embodiments, the image storage device 32 may simply be a module within memory 24. As can be appreciated, the base stations 12 of the present invention will vary, and may include fewer or more elements than illustrated in FIG. 9.

Depending on the particular scanning beam device 14 used, the light source 28 may emit a continuous stream of light, modulated light, or a stream of light pulses. Base station 12 may comprise a plurality of different light sources 28 so as to be able to operate different scanning beam devices that have different illumination capabilities. The light sources 28 may include one or more of a red light source, blue light source, green light source (collectively referred to herein as a “RGB light source”), an IR light source, a UV light source, and/or a high intensity laser source (typically for a therapeutic scanning beam device). The light sources 28 themselves may be configured to be switchable between a first mode (e.g., continuous stream) and a second mode (e.g., stream of light pulses). For ease of reference, other conventional elements in the light source are not shown. For example, if a RGB light source is used, the light sources may include a combiner to combine the different light before it enters the scanning element 34. Furthermore, while light source 28 is illustrated in FIG. 10 as being separate from base station 12, it should be appreciated that in other embodiments, light sources 28 may be integrated within base station 12.

Memory 24 may be used for storing the software modules that carry out the methods of the present invention, look-up tables, customized drive signals, algorithms that control the operation and calibration of the scanning beam device 14 and/or the image generation algorithms described above. The control routine used by the controller 20 for controlling the scanning beam device 14 will typically be configurable so as to match the operating parameters of the attached device (e.g., resonant frequency, voltage limits, zoom capability, color capability, etc.). As noted below, memory 24 may also be used for storing the image data received from the detection assembly of the scanning beam device 14, image remapping look-up tables and algorithms, remapped drive signals, parameters of the fiber scanning device, etc.

For ease of reference, other conventional elements in the base station 12 are not shown. For example, embodiments of the base stations 12 of the present invention will typically include conventional elements such as amplifiers, D/A converters and A/D converters, clocks, waveform generators, and the like.

The scanning beam devices 14 of the present invention includes a scanning element 34 for delivering and scanning a beam of light onto a target area 36. A waveguide 38, typically in the form of an optical fiber, is optically coupled to the light source(s) so as to deliver illumination from the light source 28 to the scanning element 34. A driving assembly 40 is coupled to the scanning element 34 and is adapted to actuate the scanning element 34 according to a drive signal received from the controller 20. Optionally, the scanning beam device 14 may include a non-volatile memory 39 for storing identification data or parametric data of the scanning beam device 14. A more complete description of non-volatile memory and the data that may be stored on memory 39 may be found in commonly owned U.S. patent application Ser. No. 10/956,473, filed Oct. 1, 2004, entitled “Configuration Memory for a Scanning Beam Device,” the complete disclosure of which is incorporated herein by reference.

As shown in FIG. 10, in a preferred embodiment, the scanning element 34 is a cantilevered optical fiber 50. The optical fiber 50 will comprise a proximal portion 52 and a distal portion 54 that comprises a distal tip 56. Optical fiber 50 is typically fixed along at least one point of the optical fiber so as to be cantilevered such that the distal portion 54 is free to be deflected. In such an embodiment, the proximal portion 52 of the optical fiber is the waveguide 38 and will transmit light from light source 28. As can be appreciated, in other embodiments, a separate waveguide 38 may be optically coupled to the proximal portion 52 of the optical fiber so that light from light source 28 will be directed into the optical fiber 50 and out of the distal tip 56.

The optical fiber 50 may have any desired dimensions and cross-sectional shape. The optical fiber 50 may have a symmetrical cross sectional profile or an asymmetrical cross-sectional profile, depending on the desired characteristics of the device. An optical fiber 50 with a round cross-section will have substantially the same resonance characteristics about any two orthogonal axes, while an optical fiber with an asymmetric cross section (e.g., ellipse) will have different resonant frequencies about the major and minor axes. If desired, the optical fiber 50 may be linearly or non-linearly tapered.

To achieve the deflection of the distal portion 54 of the optical fiber, the cantilevered distal portion 54 of the optical fiber 50 will be coupled to drive assembly 40. As shown in FIG. 1, drive assembly 40 will typically drive the cantilevered distal portion 54 within a Q-factor of the resonant frequency, and preferably at its mechanical or vibratory resonant frequency (or harmonics of the resonant frequency) in a one or two dimensional scan pattern. As can be appreciated, the scanning element 34 does not have to be driven at substantially the resonant frequency, but if the scanning element 34 is not scanned at its resonant frequency, a larger amount of energy will be required to provide the desired radial displacement for the scan pattern. In one preferred embodiment, the drive assembly is a piezoelectric driving assembly. A drive signal from controller 20 delivers a desired signal to the drive assembly 40. The drive signal causes the piezoelectric drive assembly to deflect the distal tip 56 of the optical fiber 50 so that the illumination spot is moved in a desired scan pattern.

Referring again to FIG. 10, the scanning beam device 14 may optionally comprise one or more lenses 58 near the distal end of the optical fiber 50 to focus the imaging light, to provide better resolution, and/or an improved FOV. The lenses 58 may be coupled to an outer housing (not shown) of the scanning fiber device 14 and fixed relative to the scanning distal end 56 of the optical fiber and/or the lens 58 may be movable relative to the housing (not shown). In preferred embodiments, the lenses 58 are modified to control the diffraction of the light reflected from the target area. A more complete description of some useful lenses 58 that may be used with the scanning beam device 14 of the present invention is described in commonly owned and copending U.S. patent application Ser. No. 11/065,224, filed Feb. 23, 2005, entitled “Scanning Beam Device with Detector Assembly,” the complete disclosure of which is incorporated herein by reference.

A detection assembly 44 may comprise one or more detectors that are in communication with the controller. While the methods of the present invention are able to create a multi-colored image with only a single detector, the scanning beam devices 14 of the present invention will often have 2 or 3 separate detectors to allow for specular color rejection

The detector(s) are typically coupled to the controller through an amplifier and A/D converter (not shown). The controller (or drive electronics within the controller) may provide a synchronization pulse to provide a timing signal for the data acquisition by the detection assembly 44. Additionally or alternatively, a separate clock circuit (not shown) may be used to correspond the detected light to the time points in the scan pattern. The detection assembly 44 may be disposed anywhere on or within the housing of the scanning fiber device, but will typically be positioned adjacent the distal portion 54 of optical fiber 50 so as to capture backscattered light reflected off of the target area 36. The detection assembly 44 may comprise one of more individual detectors to receive light backscattered from the target area 36. For example, the detection assembly may comprise a light detector (such as a photodetector) that produces electrical signal that are conveyed through leads (not shown) to the base station 12. Alternatively, the detection assembly 44 may comprise one or more collector fibers (not shown) that transmit light reflected from the target area to photodetectors in the base station 12.

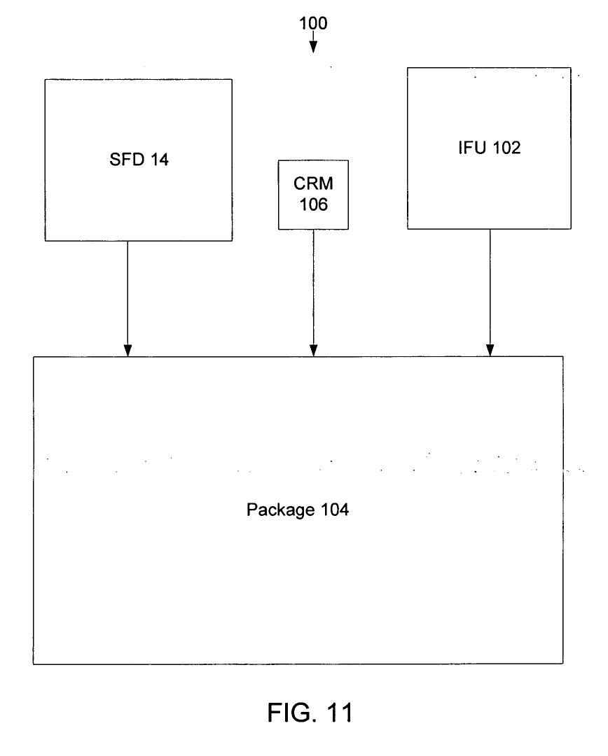

Referring now to FIG. 11, the present invention also encompasses kits 100. The kit 100 may include a scanning fiber device (SFD) 14 (such as an endoscope), instructions for use (IFU) 102, and at least one package 104. Optionally, the kit 100 may include a computer readable medium (CRM) 106 that is integral with the SFD 14 (such as the non-volatile memory 39) or separate from the SFD (e.g., CD, DVD, floppy disk, etc.)

The scanning fiber device 14 will generally be as described above, and the instruction for use (IFU) 102 will set forth any of the methods described above. Package 104 may be any conventional device packaging, including pouches, trays, boxes, tubes, or the like. IFU 102 will usually be printed on a separate piece of paper, but may also be printed in whole or in part on a portion of the package 104.

The scanning fiber devices may comprise a memory 39 that comprises a look-up table that provides a modified drive signal that comprises the first component for scanning the optical fiber over the target area and second component for quickly removing stored energy from the optical fiber and/or other parametric information regarding the scanning fiber device. Alternatively, a separate computer readable medium 106 may comprise the customized look-up table or algorithm for the drive signal, and/or the parametric data of the scanning fiber device.

It is understood that the examples and embodiments described herein are for illustrative purposes only and that various modifications or changes in light thereof will be suggested to persons skilled in the art and are to be included within the spirit and purview of this application and scope of the appended claims. For example, similar methods and systems may be applied in combined imaging and therapeutic applications. For example, in typical therapeutic applications, a therapeutic source only needs to illuminate a specific area. The specific area can be centered using the image capture capability of the scanning beam devices of the present invention. In the center, the illuminated spot is moving at a slower linear speed. Consequently, the therapeutic source can illuminate the specific area for a longer time with greater positional accuracy.

Additionally, while the present invention is described herein as using scan pattern that has a constant spacing between each spiral, it may be possible to vary the spacing between adjacent spirals by modifying the drive signals. Moreover, instead of providing a constant rate of scanning and modulation between the illumination sources, it is possible to scan and modulate the illumination source at a non-constant rate. Numerous different combinations are possible, and such combinations are considered to be part of the present invention.

What is claimed is:

1. A method comprising:
positioning a scanning beam device adjacent a target area;
scanning illumination over the target area in a scan pattern, wherein scanning comprises:
continuously modulating multiple illumination sources over a first portion of the scan pattern; and
scanning a single illumination source over a second portion of the scan pattern;
generating an image in which a first portion of the image is displayed in multiple colors and a second portion of the image is monochromatic.

2. The method of claim 1 wherein the scan pattern is a spiral scan pattern, wherein the first portion of the scan pattern is a central portion of the scan pattern and the second portion of the scan pattern is an outer, annular portion surrounding the central portion.

3. The method of claim 2 wherein the first portion of the image corresponds to the first portion of the scan pattern and the second portion of the image corresponds to the second portion of the scan pattern.

4. The method of claim 1 wherein scanning comprises:
scanning multiple illumination sources over a transition portion of the scan pattern between the first portion of the scan pattern and the second portion of the scan pattern,
wherein the multiple illumination sources in the transition portion of the scan pattern is less than the multiple illumination sources of the first portion of the scan pattern.

5. The method of claim 1 wherein the scanning beam device comprises a flexible endoscope.

6. The method of claim 1 wherein generating an image comprises collecting light reflected from the target area with one or more light detector.

7. A method comprising:
positioning a scanning beam device adjacent a target area;
sequentially scanning different illumination sources in a scan pattern over the target area;
collecting light reflected from the target area during scanning of each of the illumination sources;
using the reflected light from the target area to generate monochromatic images of the target area;
combining the monochromatic images of the different illumination sources to generate a multiple colored image of the target area; and
updating the multiple-colored image of the target area by replacing one monochromatic image with a subsequently generated monochromatic image of the same color.

8. The method of claim 7 wherein the monochromatic images comprise red, blue, and green images.

9. The method of claim 7 wherein the scan pattern comprises a raster scan pattern.

10. The method of claim 7 wherein the scan pattern comprises a spiral scan pattern.

11. The method of claim 7 wherein each monochromatic images are used in at least three multiple-colored images of the target area.

12. The method of clam 7 comprising:
extracting features from each monochromatic image;
comparing a position and orientation of the extracted features in the monochromatic images to determine misalignment between the monochromatic images.

13. The method of claim 12 comprising translating and/or rotating the previously generated monochromatic image to align it with the subsequently generated monochromatic images.

14. The method of claim 7 wherein the scanning beam device is a flexible endoscope.

15. A method comprising
positioning a scanning beam device adjacent a target area;
scanning illumination over the target area in a scan pattern to generate a frame image in which a first portion of the target area is scanned in multiple colors and a second portion of the image is monochromatic;
sequentially changing the illumination source that is used to scan the second portion of the image so that the second portion of a subsequently generated frame images is in a different color from the previous frame image;
combining a plurality of frame images which have different colored second portions to generate a multiple-colored image of the target area in both the first portion and the second portion of the image; and
updating the first portion of the multiple-colored image with every subsequently generated frame image and updating one color of the second portion with every subsequently generated frame image.

16. The method of claim 15 wherein the scan pattern is a spiral scan pattern, wherein the first portion of the scan pattern is a central portion of the scan pattern and the second portion of the scan pattern is an outer, annular portion surrounding the central portion.

17. The method of claim 16 wherein the first portion of the image corresponds to the first portion of the scan pattern and the second portion of the image corresponds to the second portion of the scan pattern.

18. The method of claim 17 wherein the first portion of the scan pattern comprises modulating multiple illumination sources at a constant or non-constant rate and the second portion of the scan pattern comprises scanning a single illumination source at a constant or non constant rate.

19. The method of claim 16 wherein scanning comprises:
scanning multiple illumination sources over a transition portion of the scan pattern between the first portion of the scan pattern and the second portion of the scan pattern,
wherein the multiple illumination sources in the transition portion of the scan pattern is less than the multiple illumination sources of the first portion of the scan pattern.

20. The method of claim 15 wherein the scanning beam device comprises a flexible endoscope.

21. The method of claim 15 comprising
extracting features from each frame image;
comparing a position and orientation of the extracted features in the frame images to determine misalignment between the frame images.
translating and/or rotating the second portion(s) of the previously generated frame image to align it with the second portion of the subsequently generated frame images.
